(19) United States
(12) Patent Application Publication
(10) Pub. No.: US 2025/0363501 A1
(43) Pub. Date: Nov. 27, 2025

(54) SYSTEM AND METHOD FOR IMPROVED MONITORING COMPLIANCE WITHIN AN ENTERPRISE

(71) Applicant: Honeywell International Inc., Charlotte, NC (US)

(72) Inventors: Mitchell O'Brien, Tempe, AZ (US); Andrew Martin, Doraville, GA (US); Michael Carey, Phoenix, AZ (US); Suzanna Thompson, Durham, NC (US); Joseph Featherstone, Milton, GA (US); Hillary Levun, Charlotte, NC (US); Marysol Palos, Charlotte, NC (US); Sabina Azizli, Fulshear, TX (US)

(21) Appl. No.: 18/674,952

(22) Filed: May 27, 2024

(51) Int. Cl. G06Q 30/018; H04L 67/306

(52) U.S. Cl. CPC G06Q 30/018; H04L 67/306

(57) ABSTRACT

The present disclosure relates to a system and method for improved monitoring compliance within an enterprise based on inputs received from stakeholders. The present invention provides a system for generation of compliance model and updation of compliance model based in changes in regulatory compliances. The generation model is configured to generate a first set of labels and a first set of data points. Further, the first set of labels are validated by one or more said user to generate a second set of labels for additional data points based on validation of first set of labels. The generation of first and second set of label generates training ready data from the first and second set of labels for training a data model. Further, the present invention provides for updating of compliance model based on update in regulatory compliance rules. In updating the compliance model, the system provides generation of third set of labels corresponding to additional data points corresponding to new rules/compliance and the third set of labels are validated by users and the validated labels are used for re-training the compliance model.

### FIELD OF INVENTION

The present invention relates to a system and method for monitoring compliance, and specifically relates to a system and method for generating and updating a compliance model for monitoring compliance within an enterprise.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Entities such as companies, industries, and business enterprises are bound by a plurality of rules and compliances. Adherence to such rules and compliances may be essential for a variety of reasons. Such compliances imposed on an entity may either be regulatory compliances or corporate compliances. Regulatory compliances applicable to entities are imposed by external regulations such as national and international compliance laws and regulations. Compliance laws applicable to an entity may be based on the nature of activities or operations performed by the entity. Compliance with national and international laws and regulations are essential for entities for protecting themselves from legal actions and penalties. In addition to protecting themselves from legal actions, compliances are followed by entities for various reasons including maintaining of the trust and reputation of the entity, reducing business risks, accessing funding and investment opportunities, and navigating complex regulatory frameworks.

In addition to regulatory compliances, the entities may be bound by corporate compliances, which are imposed by the entities on them may impose compliance requirements on themselves to meet certain standards, and goals of the entities. The legal and self-imposed compliance requirements may be imposed on the entity as a whole, and may also be imposed for individual enterprises, departments, or subsidiaries of the entity. In such scenarios, monitoring of non-compliant behavior by employees of the enterprises, or by the enterprise as a whole is to be performed to ensure that compliance requirements and rules imposed on an entity is met and abided by. Depending upon the size of the entity, the number of enterprises within the entity, and possible self-imposed compliances, there may a high number of compliances to be met by the entity. In such scenarios, keeping track of all the compliances and monitoring non-compliant behaviors may be difficult to perform with respect to an entity. In light of such compliance monitoring requirements, there is an increasing need for methods or models for monitoring non-compliant behavior.

Through applied effort, ingenuity, and innovation, the inventors have solved the above problem(s) by developing the solutions embodied in the present disclosure, the details of which are described further herein.

### SUMMARY OF INVENTION

In general, embodiments of the present disclosure herein provide a system and method for improved monitoring compliance within an enterprise. Other implementations will be, or will become, apparent to one with skill in the art upon examination of the following figures and detailed description. It is intended that all such additional implementations be included within this description be within the scope of the disclosure and be protected within the scope of the claims.

The present disclosure relates to a system and method for improved monitoring compliance within an enterprise based on inputs received from stakeholders. The stakeholders include individuals of a company or enterprise responsible for monitoring and ensuring legal, regulatory and any other compliance requirements of the company or enterprise. The system is also configured to update the model for monitoring compliance based on user feedback and training the system to improve the accuracy of the monitoring.

In an embodiment, the present invention provides a system for generation of compliance model. The system includes one or more enterprises each having one or more user devices. The enterprise is connected to an interface module of a model generation and updating system through a network. The interface module provides an interface for managing the input and output operations of the model generation and updating system. The inputs collected from the one or more user devices is transmitted to a generation module for generating a model for monitoring compliance, and/or is transmitted to the update module for updating an existing model for monitoring compliance that has already been generated by the system.

In an embodiment, the generation module initiates the generation of a learning model by receiving from the stakeholder a use case (i.e. business rules or similar inputs relating to an activity/behaviour to be monitored) using a set-up sub-module. The use case setup may be performed separately by a stakeholder where the stakeholder defines users, roles, use case output, base data etc. to be used for monitoring compliance. At the initial stage of engagement for creation of business rules for a particular monitoring, available knowledge in form of rules is obtained as input from a stakeholder in the enterprise. Along with user input, other information such as users, roles, use case output, and base data is obtained from a database or similar repository. The set-up sub-module is also configured to retrieve information in the form of existing labelled data and synthetic data.

A generative model sub-module is used to generate data points and a first set of labels and is provided by the stakeholders. The label generation sub-module present the first set of data points and first set of labels to users for validation via a user interface on the one or more devices. The user interface is populated with unlabelled data and visuals that communicate the objective of the task and provide an interaction mechanism with the user. The label generation sub-module receives as input from the stakeholder the labels to be provided for the selected data points or validation on the generated first set of labels. The labels are provided by the stakeholders through one or more devices in the enterprise using the interface module. The providing of labels for the data points by the stakeholder results in generation of training ready data for building a foundational model using the labelled data.

In a further embodiment, based on the insights obtained from the stakeholders in the form of labelling of selected data points, a label generation sub module converts the insights into input for a generative model, which is used to label additional data points and generates a second set of labels which is further provided to the user for validation. Based on validation of second set of labels, a training ready data is created for executing the compliance model. Further, in an embodiment, the label generation module provides confidence score for the generated labels. This process of generation of labels for data points and performing the validation by iteratively loop tunes the output of the generative model, until performance goals are met. Once the performance level is achieved, a compliance model is generated and validated in a similar fashion. This compliance model is then deployed and is used as the learning model for monitoring compliances. The results from the compliance model may be presented to the stakeholder via the user interface.

In yet another embodiment, the present invention provides for updating of compliance model. The system provides an update module for updating the compliance model. The model may also be updated based on change of rules related to a compliance, or based on a new type of compliance required for an existing activity/behaviour. Updating of the compliance model by the update module is initiated by accessing the compliance model developed by the system. When the retrieved model is to be updated to improve performance, an update data points sub-module presents the data points the system is most uncertain about. Queries are raised by the sub-module based on which stakeholders provide labelling for the uncertain data points, and information received for such data points are used for re-training the model.

This process of re-training the model and the confirmation and validation is iteratively performed in a loop to tune the output of the generative model until performance goals are met. The model obtained after re-training is considered as the compliance model for monitoring compliance. When model for monitoring compliance is required to be updated due to changes in the criteria/requirements of the compliance, the requirement for the new/updated compliance is communicated by the enterprise, and a similarity analysis is run by an update compliance sub-module for selecting data points to focus on. The points are labelled or identified, and based on the labels the model is re-trained iteratively, in a loop. The retrained model is considered as the model for monitoring compliance generated by the system.

The system further provides a non-transitory computer-readable storage medium storing program instructions for monitoring compliance and updating the compliance model according to embodiments of the present invention.

The above summary is provided merely for the purpose of summarizing some exemplary embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF DRAWINGS

Having thus described the embodiments of the disclosure in general terms, reference now will be made to the accompanying drawings, which are not necessarily drawn to scale, and wherein:

FIG. 1 illustrates a system for generating a compliance model based on stakeholder feedback, in accordance with an embodiment of the present invention.

FIG. 1(a) illustrates a detailed functioning of different sub-modules of the generation module for generating labels of data points, in accordance with an embodiment of the present invention.

FIG. 2 illustrates a system for updating a compliance model based on stakeholder feedback, in accordance with an embodiment of the present invention.

FIG. 3 illustrates a system for generating and updating a compliance model based on stakeholder feedback, in accordance with an embodiment of the present invention.

FIG. 4 illustrates an exemplary embodiment of a hardware infrastructure of a system generating and updating a compliance model, in accordance with an embodiment of the present invention.

FIG. 5 illustrates a flowchart of the method performed for generating a compliance model based on the generation module, in accordance with an embodiment of the present invention.

FIG. 6 illustrates a flowchart of the method performed for updating a compliance model based on the update module, in accordance with an embodiment of the present invention.

### DESCRIPTION OF THE INVENTION

The detailed description set forth below in connection with the appended drawings is intended as a description of various embodiments of the present invention and is not intended to represent the only embodiments in which the present invention may be practiced. Each embodiment described in this invention is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Some embodiments of the present disclosure now will be described hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

Companies and large establishments are required to follow multiple compliances set by different sources. A company or an establishment may be required to comply with a plurality of compliance requirements which may be set internally to meet the establishment's goals, or set by international and national laws. Compliance with such requirements and rules are important to a company for a variety of reasons. The compliance with such requirements is hence essential to every establishment, and the monitoring of such compliance may be performed for a single enterprise, wing, or department of an establishment, or to the establishment as a whole.

In certain instances, compliances of individual enterprises of an establishment and the establishment as a whole may be required to be monitored for effective governance and management of the establishment. Effective monitoring of compliance requirements and rules becomes increasingly difficult for an establishment as its size and number of compliances increases. Development of an effective method of monitoring compliances for large companies and establishments is hence an essential need, as the cost of non-compliance can impact the operations, resulting in not meeting the internal goals of a company and the mitigation of penalties.

The present disclosure relates to a system and method for improved monitoring of compliance within an enterprise based on input provided by stakeholders. An enterprise refers to a departments, wing or subsidiary of a company whose compliance requirements are to be monitored for managing the compliance requirements of the company. A company may comprise of one or more enterprises, and hence it is essential to monitor the compliances of all enterprises of a company to ensure compliance requirements of the company are met. The system proposed in the present disclosure is used to generate a compliance model for monitoring different compliances of one or more enterprises of a company. Further, the proposed system is used to update the compliance model based on changes to the compliance requirements required to be met by the enterprise.

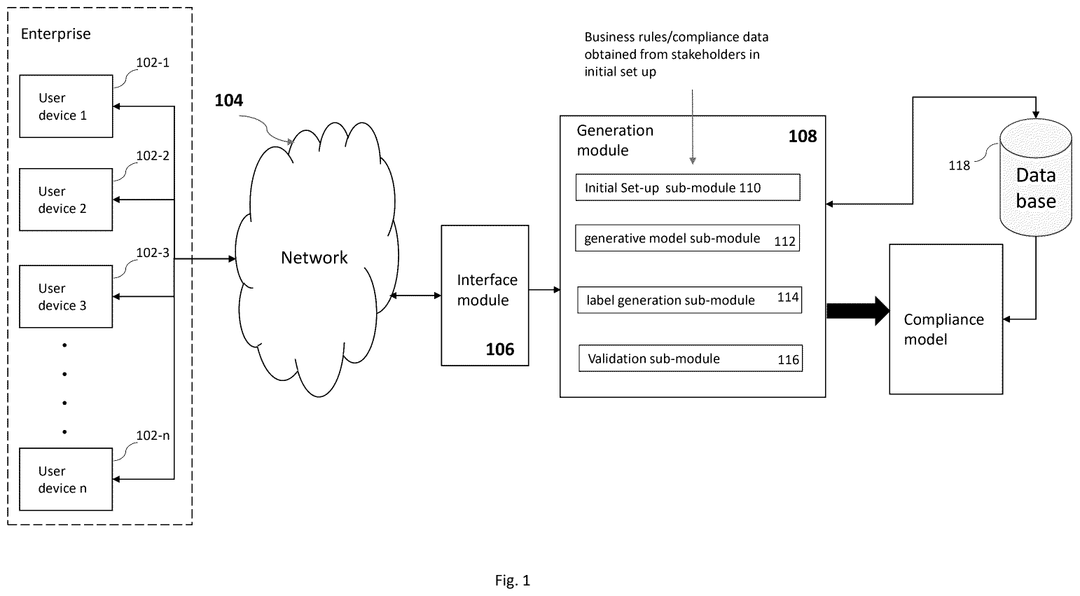

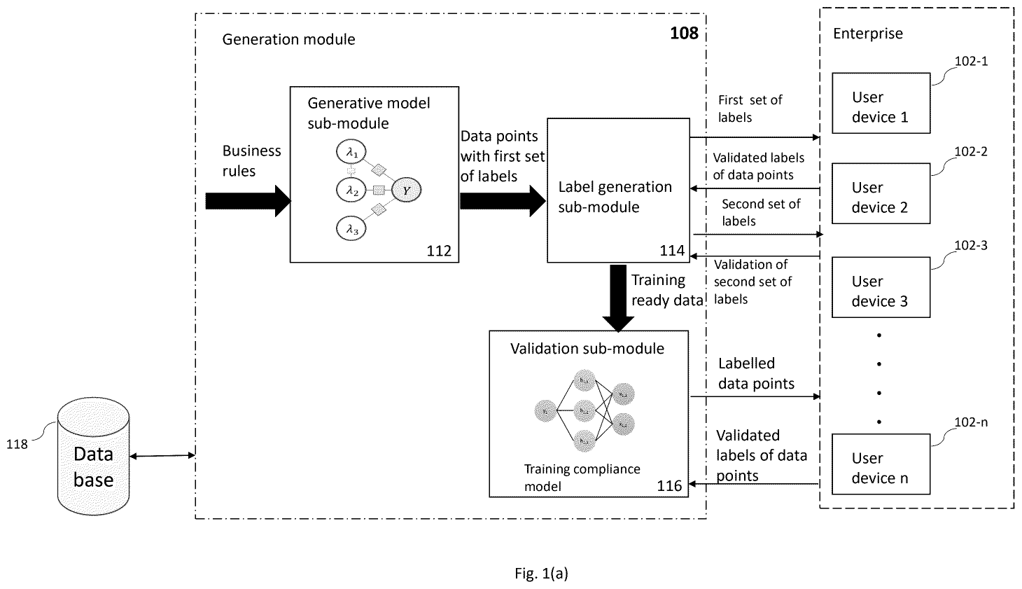

FIG. 1 illustrates a system for generating a compliance model based on stakeholder feedback, in accordance with an embodiment of the present invention. The compliance model may be connected to one or more enterprises of an establishment, and hence may be used for the monitoring of a single enterprise or a plurality of enterprises. As illustrated, each enterprise may comprise one or more user devices 102-1 to 102-n (collectively labelled 102), and the user devices 102 may be devices used for providing input such as computers, laptops, or mobile phones used by stakeholders to provide input used for generating the compliance model. One or more user operating the user device may be termed as a stakeholder. Stakeholders of a company generally include individuals such as investors, employees, and customers who are responsible for individually monitoring compliances and therefore, inputs from such stakeholders are essential for generating a compliance model, and the inputs provided by the stakeholders to the system 100 for the generation of the compliance model may include one or more of internal compliance rules or requirements, compliances laws to be followed, stakeholder's view or understanding regarding risky behaviour etc.

The system 100 for generating a compliance model comprises of a network 104, an interface module 106 and a generation module 108. The inputs obtained from the stakeholders by means of the user devices 102 are received by the generation module 108 using the network 104 and the interface 108.

The network 104 may be a local network or a cloud-based network for connecting different user devices 102 to the generation module 108, so as to enable the generation of a compliance model based on inputs and insights provided by the stakeholders of enterprises. One or more users 102 are coupled to the generation module 108 though an interface module 106. In an embodiment, the interface module 106 provides a virtual interface to one or more users to provide input to the generation module. Further, the interface module 106 is configured to provide output of the compliance module to one or more users. The interface module 106 may be customized interface which is modelled to receive specific inputs from the users.

The compliance model is a model which primarily trains on data accumulated from the stakeholders based on business rules. The data based on which the compliance model operates may include different types of data generated by the operation or functioning of an enterprise such as the transaction data, financial data, data relating to employees, data relating to output of the enterprise etc. A compliance model generated for a particular enterprise may have varying performance or requirements based on the difference in nature or values of such data generated by the enterprise. The performance of the compliance model may also be governed or dependent on the business rules used for generating such a compliance model. In order for compliance model to run and provide output on compliance metrics, the training data is generated and is provided by the generation module 108, which is explained further below.

The inputs or insights of the stakeholders are collected from the user devices 102 based on the interface module 106. The interface module 106 is used to customize or configure the method by which the insights are obtained from the stakeholders, and such configuration is achieved by the interface module 106 by creating a visually informative and interactive user interface at the user devices 102. The interface is created based on configurations provided by the interface module 106 with the assistance of the network 104. The user interface generated at the user device 102 by the interface module enables collection of data or information from the stakeholders in a manner that is easy for the stakeholders. The methods of providing inputs supported by the interface module 106 includes feedback in the form of ratings or feedback forms, rating the level of risk related with a particular operation of the enterprise etc.

The interface module 106 is also used for providing outputs relating to the functioning or results obtained from the generation module 108 to the users. The output may be displayed in the user devices 102 in a manner that is interactive and easy to understand for the stakeholders, and a combination of the input and output operations of the interface module 106 is used for effective interaction of the system 100 with the stakeholders of the enterprises.

The inputs or insights of the stakeholders obtained based on the configuration of inputs by the interface module is provided to the generation module 108 using the network 104. The generation module 108 comprises a plurality of sub-modules used for generating a compliance model based on the insights obtained from the stakeholders. The sub-modules comprised by the generation module 108 include initial set-up module 110, a generative model sub-module 112, a label generation sub-module 114, and a validation sub-module 116.

During initial set up, the operation begins with scoping expectations or obtaining an understanding of the use case of the compliance model and relating it to the business objectives that are set based on the compliance related goals of the enterprise. The use case of the compliance model relates to the specific use or purpose for which the compliance model is being generated, i.e., the nature of monitoring that is to be performed by the compliance model and the nature and type of data that is to be processed by the compliance model for the purpose of monitoring compliance. For determining the use case of the compliance model, inputs related to the use case is received from one or more stakeholders.

In one embodiment, the use case of the compliance model may be mutually agreed upon by the stakeholders by way of discussion or agreement. The use case may be provided as a single input from any one of the user devices, and the input may be provided using a text-based form, checklist, or any such format of providing input, which may be filled by any one of the stakeholders. In another embodiment, the use case of the compliance model may be determined based on the insights provided by one or more stakeholders. In such an embodiment, use case determined by the set-up sub-module may be a compilation of a variety of inputs provided by different stakeholders, wherein the inputs may be collected using one or more formats. In addition to the use case, the inputs retrieved from the stakeholders helps in developing an understanding regarding the basic requirements required for generating the compliance model.

The initial understanding on insights for required compliance and associated data, the collected data and feedback are used as a guideline for the generation of the compliance model. After determination and confirmation of the use case based on the insights of the stakeholders, the initial set up includes providing an understanding or educating the stakeholders regarding the data generated by the enterprises, and different aspects relating to such data including the nature of data, the volume and complexity of data, and the monitoring that is to be performed by the compliance model to be generated based on such data. The process of educating the stakeholders regarding the data generated by their enterprise and for the generation and implementation of the compliance model is performed to ensure that the stakeholders reconcile with their preconceived notions regarding the compliance model to be generated, and the functions it would perform.

In an embodiment, the use case relating to compliance model and rules/business rules are stored and set up in the initial set-up module 110. The generative model sub-module 112 of the generation module 108 uses inputs relating to the business rules and compliance requirements from the stakeholders collected by the initial set-up module 110 and generates one or more data points. The compliances imposed on the enterprise, both corporate regulatory, are adopted as business rules used to generate data points on which the compliance model will be trained.

In addition to generating data points based on business rules/compliance requirement, the generative model sub-module 112 is configured to retrieve existing labelled data available to the stakeholders, and synthetic data. Existing labelled data may include raw data relating to the compliance requirements or rules to be followed by the enterprise which has been labelled by the enterprise to provide context regarding the properties of the data. Such labels are generally provided to raw data so as to enable or aid the training of ML (Machine Learning) models or AI (Artificial Intelligence) models, wherein the labels are used for supervising the training of such models. Further, synthetic data provided by the stakeholders may also relate to the compliance requirements and rules that are to be followed by the enterprise. Such synthetic data is not generated based on natural or real-world events related to the operation of the enterprise, and is instead generated artificially or based on algorithms executed by stakeholders of the enterprise as a stand-in for test data sets of production or operational data. Such synthetic data is generated to validate mathematical models and train ML models.

Based on the business rules, existing labelled data, and synthetic data obtained from the stakeholders relating to the compliance requirements and rules to be followed by the enterprise, a generative model is generated. The generative model uses neural networks to identify the patterns and structures within existing data to generate new content. The generative model leverages different learning processes including supervised and unsupervised learning for training of the generative model. Data including the business rules, labelled data, and synthetic data retrieved by the generative model sub-module 112 is used for creating the generative model. The generative model created by the generative model sub-module 112 is designed to learn underlying patterns in such data sets and use that knowledge to generate new samples similar but not identical to the original data set.

After creation of the generative model, the generative model sub-module 112 is used to generate data points used for training of the compliance model. The data points are generated by the generative model based on the business rules applicable for the enterprise. In an embodiment, such data points generated by the generative model is unlabelled, and labels are required to be provided for such unlabelled data to obtain training ready data.

In one embodiment, the generative model sub-module 112 generates a first set of labels (may be referred to as weak labels) for the data points, and the first set of labels are generated based on the data relating to the enterprise and compliance data available to the generative model sub-module 112. The generation of the first set of labels by the generative model may be based on the application of labelling functions generated by subject matter experts and data scientists of the enterprise. Such labelling functions are generated by such individuals based on the factors relating to the enterprise including compliances applicable to the enterprise and the compliance model required for the enterprise.

Further, at least some of the data points and the corresponding weak labels generated by the generative model in the generative model sub-module 112 is provided to the stakeholders by the label generation sub-module 114.

In an embodiment, the label generation sub-module 114 selects some of the data points generated by the generative model for confirmation by the stakeholders, hereafter referred to as a first set of data points. The first set of data points along with its first set of label are selected, and are presented to the users through the interface module 106. The labels of the first set of data points are presented in a manner by user interface that enables the visualization of the data points by the stakeholders. The stakeholders provide a feedback on the correctness of the labels of the first set of data points, and the feedback may be in the form of confirmation of correctness or in the form of correct labels of the data points. The feedback may be collected using a visually interactive user interface created by the interface module 106, and may be collected by the interface by means including a feedback form, a feedback rating indicating the level of accuracy of the labels, or as a list of correct labels corresponding to the data points with incorrect labels.

The feedback provided by the stakeholders is retrieved by the label generation sub-module 114. The feedback may include validation of first set of labels or the user may suggest new label for the selected data points. Such insights provided by the stakeholders may be used by the label generation sub-module 114 for updating the labels of the remaining data points thereby providing a second set of labels.

In addition to the generation of second set of labels, the label generation sub-module 114 also generates confidence estimates for each of the labels corresponding to all the data points. Confidence estimate provided by the generative model for a label may indicate the level of confidence of correctness of the label for a data point. The confidence estimate is indicated in terms of some quantitative or qualitative value, so as to enable a comparison in the confidence estimates of the different data points. In one embodiment, the confidence estimates of the labels generated by the generative model may be indicated in terms of percentages, i.e., the percentage of confidence that the label provided for a data point is correct. The second set of labels for the data points and the confidence estimates associated with each label constitute training ready data.

The training ready data is confirmed and validated by the stakeholders over multiple iterations using the validation sub-module 116. The validation sub-module 116 strategically sample the labelled data points into the user interface to retrieve confirmation or validation of the correctness of the labels of data points from the stakeholders. The labelled data points are displayed in a visually interactive manner that enables ease of understanding and perceiving of the data points by the stakeholders, and retrieves confirmation or validation of the labels of the data points as feedback. The feedback may be provided in different ways depending on nature of the data and labels. The feedback provided is either a confirmation of the label of a data point or correction in the label of a data point. The feedback provided by the stakeholders is retrieved by the validation sub-module 116 as inputs for updating the labels of the data points. The labels for the data points are updated in case of a different label provided by the stakeholders, and the confidence estimates for the labels are generated afresh by the generative model.

In one embodiment, the data points having labels with associated confidence estimates below a certain predetermined value may be validated. That is, the labels of data points that the generative model is most uncertain about is provided for confirmation and validation to the stakeholders, and the labels are updated based on the feedback of the stakeholders. Correspondingly, the confidence estimates for the labels of the data points validated are updated, and labels and confidence estimate for the remaining data points may be updated based on the stakeholders feedback.

The compliance model is trained and executed based on the data points with the updated labels as training data, and the metric associated with the compliance accuracy is measured.

If the compliance accuracy is below a threshold compliance accuracy level, then the labels of the data points are confirmed and validated again by the validation sub-module 116. The labels of the data points are updated accordingly and new confidence estimates are calculated for the labels. The compliance accuracy obtained based on new training data comprising the data points with updated labels is calculated and compared with the threshold value. Such an iterative process of confirming and validating the data labels ensure that correct labels are provided for data points used for training the compliance data model. Once the compliance accuracy threshold has been achieved for the labelled data points, such data points are taken as training data for running the compliance model.

The data points generated by the generative model, and the different sets of labels generated corresponding to the date points at different stages of modelling of training of the compliance model is saved in the database 118, and hence the database 118 is used as storage of all instances of labels provided for the data points by the generative model, with or without feedback from the stakeholders.

The compliance model is generated as output of the operations performed by the different sub-modules of the generation module 108, and the compliance model thus generated is used for testing whether the compliances applicable for an enterprise have been satisfied to the necessary extent. The output of the compliance model based on input data provided by the enterprise is the percentage of compliance achieved by the enterprise based on its activities. The input data provided to the compliance model may include inputs from the stakeholders, and data generated by the enterprise stored in data logs of the enterprise. Such data logs may be accessed from databases, servers, or memory of the enterprise. The enterprise may have an internal understanding regarding the level of compliance to be achieved, and if the output of the compliance model is beyond such level of compliance, this is taken as an indication that the enterprise is abiding by the regulatory compliances. If the output of the compliance model is below such level of compliance, this is taken as an indication of non-compliant behaviour on the part of the enterprise. Hence the compliance model generated by the generation module 104 is used to monitor compliance of corporate and regulation requirements by an enterprise.

FIG. 1(a) illustrates generating labels for one or more data points according to an embodiment of the present disclosure. The generative model sub-module 112 generates unlabelled data points based on the business rules obtained from the stakeholders. Thereafter, the generative model further generates a first set of labels (also referred to as weak labels) for the abovementioned data points. Some of the labelled data points obtained thereby is provided by the label generation sub-module 114 to the stakeholders for validation.

The selected data points with weak labels are provided at the user interface created by the interface module 106 at the user devices 102, and the stakeholders provide confirmation or corrections to the weak labels of the data points from the user devices 102 as feedback. The feedback corresponding to the data points provided by the stakeholders are used by the label generation sub-module 114 for updating the labels of the corresponding data points, and are also used as insights by the generative model for generating a second set of labels for the remaining data points. The label generation sub-module 114 generates a second set of labels and associates data points to the second set of labels, and the same is further validated by the user through the interface module 106. Based on further validation, the second labels are updated by the label generation sub-module 114 to create a training ready data for compliance model and is provided to the validation sub-module 116.

The labelled data points generated by the label generation sub-module 114 forms the training ready data for training the compliance model. The training ready data obtained thereby is used by the validation sub-module 116 for training the compliance model. The accuracy of the compliance model thus obtained is computed by the validation sub-module 116, and if the accuracy of the compliance model is below a predetermined threshold, the labels of the data points may be provided to the stakeholders for further validation. The labelled data points are provided by the validation sub-module 116 to the stakeholders by a user interface created by the interface module 106 at the user devices 102. The stakeholders confirm or correct the labels of the data points, and such confirmation or corrections are retrieved by the validation sub-module 116 and corresponding changes are made to the labels of the data points. The compliance model is trained based on the updated labels of the data points, and the accuracy is computed again. Such a process of validating the labels of the data points used for training the compliance model is iteratively performed until the required accuracy is achieved by the compliance model.

The labels generated for the data points by the generative model at the generative model sub-module 112, and the labels generated by the label generation sub-module 114 and validation sub-module 116 based on feedback provided by users regarding labels of data points are stored in the database 118 by the generation sub-module 108. Hence the database 118 contains the different labels created at different instances by the sub-modules of the generation module 108 corresponding to different data points.

In one embodiment, the confidence estimate is generated by the label generation sub-module 114 for each of the weak labels. The confidence estimate reflects the level of confidence regarding the correctness of the labels provided for each of the data points. The confidence estimate of the label of a data point may be updated based on validation provided by the stakeholders. For instance, the confidence estimates for the first set of weak labels is updated after the feedback regarding the labels are provided by the stakeholders to the label-generation sub-module 114. Based on the updates made to the labels of the remaining data points by the label-generation sub-module 114 in accordance with the insights obtained from the stakeholders, the corresponding confidence estimates of the labels are also updated.

The data points, provided to the stakeholders by the validation sub-module 116 for validation due to the lack of accuracy of the compliance model, may be selected based on confidence estimates of the data points. That is, the data points with lowest confidence estimates may be provided by the validation sub-module 116 for validation of labels. The confidence estimates for such data points are updated after the labels are validated.

The enterprise for which the compliance model is generated may be liable to comply with different types of corporate and regulatory compliances. The compliance model is hence generated based on such compliances imposed on the enterprise. However, additional compliances may be imposed on the enterprise after the compliance model has been generated using the training data developed based on the previous set of compliances. Further, one or more regulatory or corporate compliances imposed on the enterprise may be lifted. Hence, the compliance model is required to be updated based on the addition or removal of corporate or regulatory compliances. An update module of the system is used to update the compliance model based on updating the training data for the compliance model.

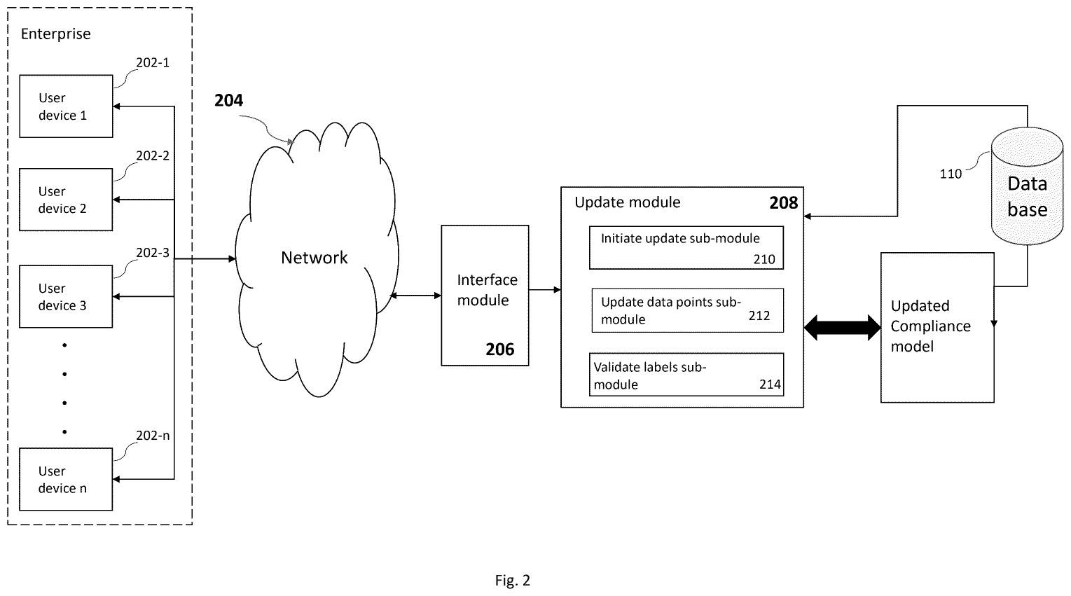

FIG. 2 illustrates a system for updating a compliance model based on stakeholder feedback, in accordance with an embodiment of the present invention. The system 200 is connected to an enterprise for which a compliance model has been generated by the generation module. Each enterprise may comprise one or more user devices 202-1 to 202-n (collectively labelled 202), and the user devices 202 may be devices used for providing input such as computers, laptops, or mobile phones used by stakeholders to provide input used for updating the compliance model. The inputs of the stakeholders are retrieved from the user devices 202 by means of a network 204. The retrieval of information through the network 204 is assisted by the interface module 204. The interface module 204 is used to create interactive user interfaces at the user devices for the stakeholders. The interface module 206 creates an interface for the transfer of communication between the user devices and the update module 208, wherein the update module 208 is used for updating the compliance model by integrating the changes in compliance requirements into the training data used for updating the compliance model. The update module 208 is connected to the database 218 used for storing information relating to the different data points and labels generated during the update process performed by the update module 208. Further, the update module 208 is also connected to the compliance model generated by the generation module.

The update module 208 comprises a plurality of sub-modules used for updating the compliance model. The sub-modules of the update module 208 include an initiate sub-module 210, an update data points sub-module 212, and a validate labels sub-module 214. The initiate sub-module 210 is used to initiate an update of the compliance model. The update is initiated based on a trigger received by the update module 214. In one embodiment, the trigger may be a request for update provided by a stakeholder. The update may relate to a need for including one or more compliances to the business rules applicable to the enterprise, or for removing one or more compliances from the business rules, or for removing some compliance and introducing new compliances. Based on such a trigger, the initiate update sub-module 210 retrieves as input from the stakeholders the changes to be made to the business rules.

The changes to be made is either an addition of new compliances to the business rules, a removal of existing compliances from the business rules, or a combination of both. If new compliances are to be included to the business rules, the initiate update sub-module 210 accesses the corresponding compliance and adds the same to the business rules. In one embodiment, the compliance may be retrieved from different sources such as servers, databases, or memory associated with the enterprise using the network 204. If a compliance is to be removed from the business rules, the initiate update sub-module 210 accesses the business rules, and removes all instances of data relating to the compliance from the business rules. If a combination of both is to be performed, the initiate update sub-module 210 accesses the business rules and the compliances to be added to the business rules, adds the compliances to the business rules and erases the compliances to be removed from the business rules. In one embodiment, the business rules corresponding to the compliance model to be updated is stored in the database 218, and is accessed by the initiate update sub-module 210 for updating the business rules so as to update the compliance model.

The update data points sub-module 212 thereafter uses a generative model for generating unlabelled data points corresponding to the new business rules. The generative model subsequently generates a third set of labels for the data points based on the information available to the generative model. Some of the labelled data points generated by the generative model is provided to the stakeholders for validation. The data points are visually represented to the stakeholders on the user interfaces created by the interface module 206 at the user devices 202. The interactive user interfaces created by the interface module 206 displays the labels of the data points, and retrieves feedback of the stakeholders on each of labels of the displayed data points. The feedback may be a confirmation if the label is correct, or the feedback may be related to the correct label for the data point. The feedbacks provided by the stakeholders is retrieved as insights by the update data points sub-module 212, and the labels of the data points provided to the stakeholders for validation are updated by the update data points sub-module 212 to reflect the insights provided by the stakeholders. The insights provided by the stakeholders are also used to generate labels for the remaining data points, and training ready data is obtained as a result. Confidence estimates for each of the labels may be created by the generative model, and the confidence estimate indicates the level of confidence in the correctness of the labels generated for each of the data points.

The training ready data, comprising of labelled data points, generated by the update data points sub-module 212 is updated over multiple iterations of validation by stakeholders using the validate labels sub-module 214. The validate labels sub-module 214 strategically sample the labelled data points to retrieve confirmation or validation of the correctness of the labels of data points from the stakeholders. The labelled data points are displayed in a visually interactive manner that enables ease of understanding and perceiving of the data points by the stakeholders, and retrieves confirmation or validation of the labels of the data points as feedback. The feedback may be provided in different ways depending on nature of the data and labels. The feedback provided is either a confirmation of the label of a data point or correction in the label of a data point. The feedback provided by the stakeholders is retrieved by the validate labels sub-module 214 as inputs for updating the labels of the data points. The labels for the data points are updated in case of a different label provided by the stakeholders, and the confidence estimates for the labels are generated afresh by the generative model.

In certain embodiments, only the set of data points with labels having low confidence estimates may be validated and confirmed by feedback provided by stakeholders using the interface module 206. In such instances, the labels are updated based on the stakeholder feedback, and confidence estimates are computed accordingly.

The compliance model is accessed by the validate labels sub-module 214 and is trained using the data points with the updated labels as training data, and the compliance model is tested to find compliance accuracy. If the compliance accuracy is below the threshold compliance accuracy level, then the labels of the data points are confirmed and validated again by the validate labels sub-module 214. The labels of the data points are updated accordingly and new confidence estimates are calculated for the labels. The compliance accuracy of the compliance model trained with new training data comprising the data points with updated labels is calculated and compared with the threshold value. Such an iterative process of confirming and validating the data labels ensure that correct labels are provided for data points used for updating the compliance data model. Once the compliance accuracy threshold has been achieved for the labelled data points, such data points are taken as training data for training the compliance model. The compliance model obtained by training with updated data points based on operation of update module 208 can thereafter be used for monitoring non-compliant behaviour of the enterprise, or for checking if required compliance levels are achieved by the enterprise. The update module 208 thus ensures that precision of the

In one embodiment, the generation module and the update module are implemented within the same system, wherein the compliance model is generated based on business rules provided by the stakeholders.

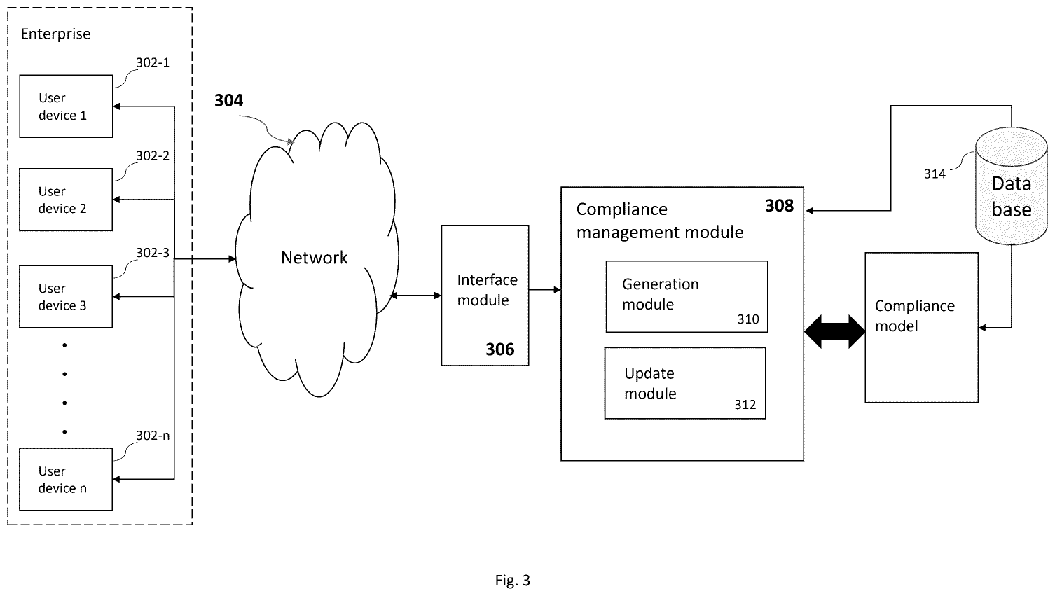

FIG. 3 illustrates a system for generating and updating a compliance model based on stakeholder feedback, in accordance with an embodiment of the present invention. The system 300 is connected to an enterprise for which a compliance model is to be generated and maintained. Each enterprise may comprise one or more user devices 302-1 to 302-n (collectively labelled 302), and the user devices 202 may be devices used for providing input such as computers, laptops, or mobile phones used by stakeholders to provide input used for updating the compliance model. The inputs of the stakeholders are retrieved from the user devices 302 by means of a network 304. The retrieval of information through the network 304 is assisted by the interface module 306. The interface module 306 is used to create interactive user interfaces at the user devices for the stakeholders. The interface module 306 creates an interface for the transfer of communication between the user devices and the compliance management module 308, wherein the compliance management module 308 is used for generating and managing a compliance model for monitoring non-compliant behaviour of the enterprise. The compliance management module 308 comprises a generation module 310 for generating a compliance model and an update module 312 for updating the compliance model created. The compliance management module 308 is connected the database 314 used for storing information relating to the enterprise, the compliances applicable to the enterprise, and data logs generated by the enterprise.

The compliance model is developed by the generation module 310 of the compliance management module 308 based on business rules applicable to the enterprise. The business rules of the enterprise include the corporate and regulatory compliances that are to be followed by the firm, and the business rules are retrieved from the stakeholders at the user devices 302 by means of an interactive user interface created by the interface module 306. The inputs relating to the business rules may be retrieved from the stakeholders as a list of compliances, and the generation module 310 may retrieve the business rules based on the list of compliances received from the stakeholders. The business rules are thereafter stored in the database 314. Unlabelled data points are created by a generative model based on the business rules, and the creation of unlabelled data points is assisted by information obtained from users such as use case of the compliance model and basic information relating to the compliance model to be generated. The generative model thereafter creates weak labels for the data points, and the weak labels may be created based on information including data logs generated by the enterprise.

A set of the data points is selected and provided to the stakeholders by the generation module 310, and the data points may be presented in an interactive manner at the user interface at user devices 302 created by the interface module 306. The labels of the data points are either confirmed or corrected by the stakeholders, wherein correction is provided as a feedback with the correct labels. The feedbacks from the stakeholders for all the data points are provided back to the generation module, where the labels are updated based on the feedback received. The data points with labels validated by the stakeholders are then used by the generative model for generating labels for the remaining data points. Thus, all the labels of the data points are updated, and training data for generating the compliance model is obtained. The training data is perfected over multiple iterations of validation provided by the stakeholder, wherein each iteration involves providing the labels to the stakeholders, receiving stakeholders' feedback regarding the labels, and updating the labels of the data points according to the feedback to update the training data. The iteration also includes computing the accuracy of the compliance level generated by a data model trained using the training data, and if the compliance level is below the required level of accuracy, the iteration is repeated again. In such a manner the training data is updated till a data model trained using such training data achieves the level of accuracy required. The training data thus obtained is used for training the compliance model.

The compliance model generated by the generation module 310 of the compliance management module 308 is updated using the update module 312 when there is a change in the compliances imposed on the enterprise. The change in the compliances may be an addition of one or more compliances, a removal of one or more compliances, or a combination of both. In any of the above-mentioned scenarios, the business rules are to be modified based on the changes in compliances, and the business rules used for developing the existing compliance model are accessed and retrieved by the update module 312 from the database 314. The compliances to be added and/or removed from the business rules are retrieved from the stakeholders at the user devices 302 by means of the interactive user interface created by the interface module 306, and the corresponding changes are made to the business rules to obtain updated business rules. The updates business rules are used by the generative model created by the generation module 310, and the generative model creates unlabelled data points based on the updates business rules.

A small set of the data points is selected and provided to the stakeholders by update module 312, and the data points may be presented in an interactive manner at the user interface at user devices 302 created by the interface module 306. The labels of the data points are either confirmed or corrected by the stakeholders, wherein correction is provided as a feedback with the correct labels. The feedbacks from the stakeholders for all the data points are provided back to the generation module, where the labels are updated based on the feedback received. The data points with labels validated by the stakeholders are then used by the generative model for generating labels for the remaining data points. Thus, all the labels of the data points are updated, and training data for generating the compliance model is obtained. The training data is perfected over multiple iterations of validation provided by the stakeholder, wherein each iteration involves providing the labels to the stakeholders, receiving stakeholders' feedback regarding the labels, and updating the labels of the data points according to the feedback to update the training data. The iteration also includes computing the accuracy of the compliance level generated by a data model trained using the training data, and if the compliance level is below the required level of accuracy, the iteration is repeated again. In such a manner the training data is updated by the update module 312 till a data model trained using such training data achieves the level of accuracy required. The training data thus obtained is used for retraining the compliance model.

The generation module and the update module, whether executed as separate embodiments or a single embodiment, may be implemented based on execution of program instructions corresponding to the plurality of sub-modules of the two main modules. In one embodiment, the program instructions corresponding to the sub-modules of generation module and the update module may be implemented on a processing unit or device.

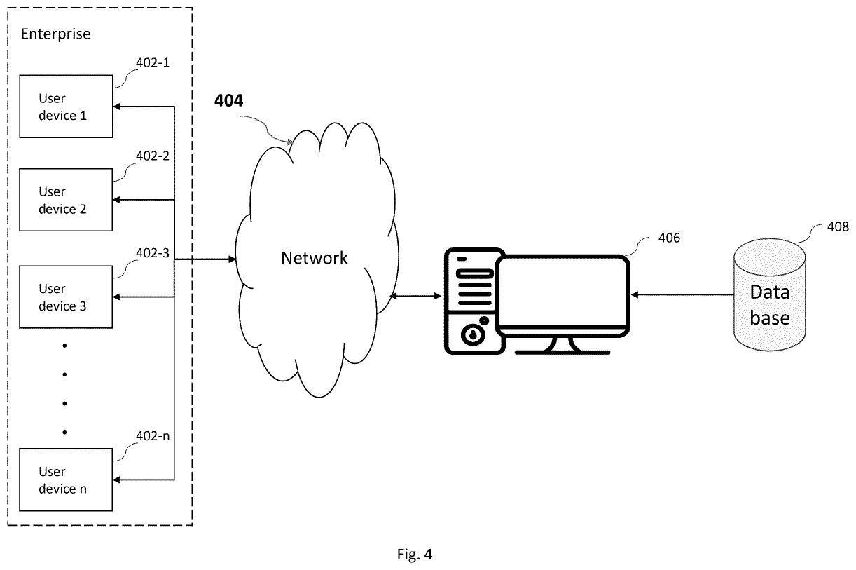

FIG. 4 illustrates an exemplary embodiment of a hardware infrastructure of a system generating and updating a compliance model, in accordance with an embodiment of the present invention. The hardware infrastructure of the system 400 comprises a plurality of user devices 402 used by stakeholders for providing inputs and insights for the development of the compliance model. The hardware infrastructure of the system 400 further comprises a network 404, a processing device 406, and a database 408. The processing unit or device may be a computer, a workstation, server etc., and is used to execute program instructions corresponding to the interface module and the sub-modules of the generation module and the update module. The user devices 402 are connected to the processing device 406 by means of the network 404, and inputs and insights from the stakeholders provided through the user devices 402 is used by the processing unit for developing the compliance model.

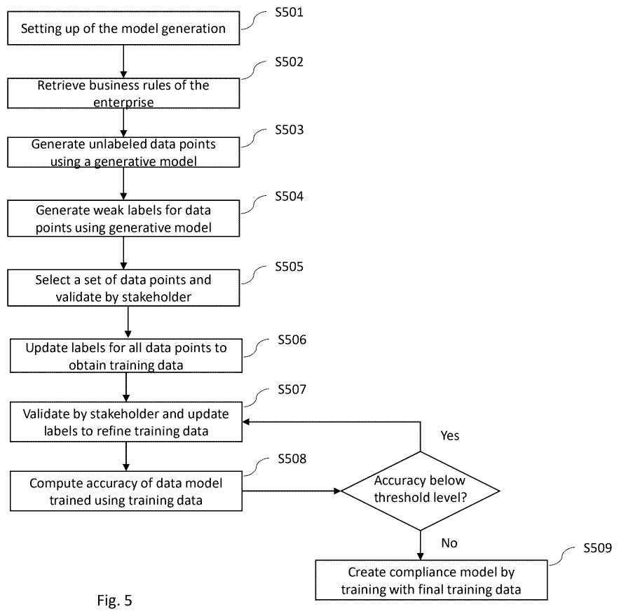

The method of generating and updating the compliance model performed by the processing device is based on the execution of programming instructions corresponding to the interface module and the sub-modules of generation and update module. FIG. 5 illustrates a flowchart of the method performed for generating a compliance model based on the generation module, in accordance with an embodiment of the present invention. The method of generating a compliance model for an enterprise initiates with the setting up of the model generation process at step S501. The setting up of the model generation process involves retrieving the use case of the compliance model to be generated, and educating and reconciling preconceived notions of the stakeholders. Step S501 also included retrieving basic information of relating to the compliances applicable to the enterprise, and context as to hierarchy of individuals within stakeholders.

After such information is collected from the stakeholders and fed into the initial set-up sub module. The generative model sub-module of the generation module is used to retrieve business rules applicable to the enterprise from the stakeholders at step S502. The business rules include corporate and regulatory compliances, i.e., the internal compliances and compliances based on national and international rules. Step S503 involves generation of unlabelled data points by a generative model based on the business rules retrieved. The generative model is also used for generating one or more data points and a first set of labels (i.e., weak labels) for the data points using information including data logs generated by the enterprise, wherein the information is accessed by the generative model from the database at step S504. Steps S502, S503, and S504 are performed using the generative model sub-module of the generation module.

In Step S505, the first set of labels and data points are selected by the label generation sub-module of the generation module. The first set of data points and labels are presented to the stakeholders for validation at step S505 where the stakeholders either confirm the correctness of the label or provide correct labels for the data points. The insights/validation performed by the stakeholders is taken as feedback. In an embodiment, the user may either validate the weak label or suggest new labels for applying to the data points. The label generation sub-module based on user's insights, updates the labels of the first set of data points according to the feedback provided at step S506 and generates a second set of labels. The second set of labels are used to label the remaining data points. The updated labels for all the data points are obtained at step S506 by the label generation sub-module. The data points with updated labels constitute a training data which may be used for the training of the compliance model.

The labelled data points with second set of labels are provided to the stakeholders for validation by the validation sub-module of the generation module at step 507. The second set of labels are updated by the validation sub-module based on user's validation thereby refining the training data for the compliance model. The training data obtained therein is used for training a data model, and performance of the data model is computed at step S508. If the performance or accuracy of the compliance estimated by the data model is below a required threshold, steps S507 and S508 are repeated iteratively till the accuracy of compliance estimated is above the required threshold. After crossing such a threshold, the training data used to achieve the output is used for training the compliance model.

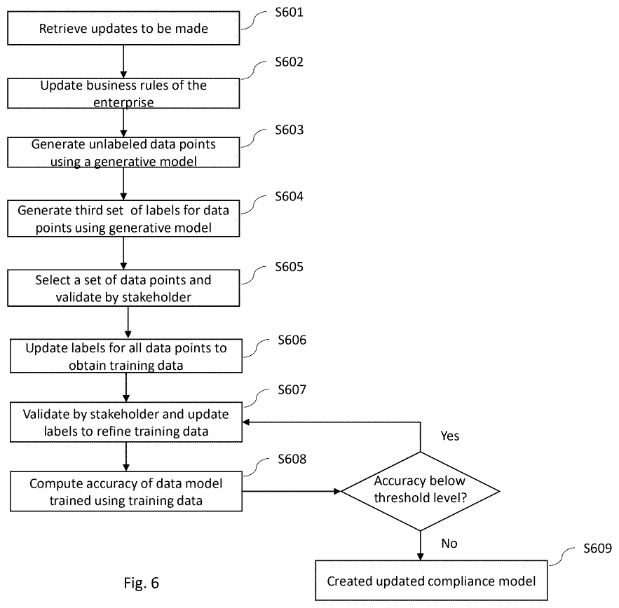

The compliance model generated by the generation module is updated as per the requirements of the stakeholders using the same system by means of the update module. FIG. 6 illustrates a flowchart of the method performed for updating a compliance model based on the update module, in accordance with an embodiment of the present invention. The method of updating the compliance model for an enterprise initiates with the retrieval of changes to be made to the business rules from the stakeholders at step S601 using initiate update sub-module of the update module. The changes to be made to the business rules may include addition of one or more compliances to the existing business rules, removal of one or more compliances from the business rules, or a combination of both. The business rules used for training the existing compliance model is retrieved from the database, and changes are made to the business rules at step S602.

Step S603 involves generation of unlabelled data points by a generative model based on the updated business rules based on operation of the update data points sub-module of the update module. The generative model is also used for generating a third set of labels for the data points using information including data logs generated by the enterprise, wherein the information is accessed by the generative model from the database at step S604. Steps S603 and S604 are performed using the update data points sub-module of the update module.

Of the labelled data points created by the update data points sub-module, the third set of labels and data points are selected by the validate sub-module of the update module at step S605. The third set of labelled data points are presented to the stakeholders for validation at step S605 where the stakeholders either confirm the correctness of the label or provide correct labels for the data points. The validation performed by the stakeholders is taken as feedback, and the validate sub-module updates the labels according to the feedback provided at step S606. The labels of the data points are used by the generative model in generating labels for the remaining data points. Hence, updated labels for all the data points are obtained at step S606 by the validate sub-module. The data points with updated labels constitute a training data which may be used for the training of the requisite compliance model.

The labelled data points are provided to the stakeholders for validation by the validate sub-module of the update module at step 607. The third set of labels are updated by the validate sub-module to refine the training data for the compliance model. The training data obtained therein is used for training a data model, and performance of the data model is computed at step S608. If the performance or accuracy of the compliance estimated by the data model is below a required threshold, steps S607 and S608 are repeated iteratively till the accuracy of compliance estimated is above the required threshold. After crossing such a threshold, the training data used to achieve the output is used for training the compliance model. The compliance model is obtained at step S609, and is an updated version of the previous compliance model.

The methods of generating the compliance model, and updating the compliance model generated based on changes in the business rules, is essential in creating a compliance model that is able to accurately compute the level of compliance of an enterprise with the regulatory and corporate compliances imposed on it. The compliance model thus obtained can be applied for different types of enterprises from different fields or involved in different activities. The compliance model may also be used to monitor the any non-compliant behaviour on the part of the enterprise, and alerts or identification of the possibility of non-compliant behaviour is useful to the enterprise for timely rectification of such non-compliance to avoid penalties or fines which may be imposed on it based on regulatory compliances.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. A method for monitoring compliance, comprising:
receiving a first set of inputs from a user, the first set of inputs comprising information relating to one or more compliance requirements to be monitored;
acquiring a profile associated with said user;
generating a first set of data points based on the first set of inputs and one or more attributes acquired from the profile associated with the user;
generating a first set of labels for at least one of the data points from the first set of data points;
validating the first set of labels by said user;
generating a second set of labels for additional data points based on validation of first set of labels;
storing in memory the first and second set of labels; and
generating training ready data from the first and second set of labels for training a data model.

2. The method of claim 1, further comprising:
communicating to the user the second set of labels;
receiving a second set of inputs from a user, the second set of inputs comprising data related to validation of each of the second set of labels;
storing in memory information relating to validation of said second set of labels; and
updating the training ready data based on the second set of inputs.

3. The method of claim 2, further comprising:
generating a query to determine the accuracy of the data model;
wherein, when the accuracy of the data model is below the predetermined value, the method further comprises:
communicating to the user the second set of labels;
receiving inputs from the user, the inputs comprising data related to validation of each of the second set of labels;
storing in memory information relating to validation of said second set of labels; and
updating the training ready data based on the inputs received from the user.

4. The method of claim 3, further comprising:
iteratively updating the second set of labels by validation of each the second set of labels by one or more users until the determined accuracy of the data model is achieved.

5. The method of claim 3 or 4, wherein the second set of labels communicated to the user correspond to confidence estimates in a predetermined range, wherein the confidence estimate for each of the second set of data labels is determined by the data model.

6. The method of claim 1, further comprising:
receiving a third set of inputs from a user, the third set of inputs comprising information relating to one or more compliance requirements;
retrieving, based on the third set of inputs and one or more attributes acquired from the profile associated with the user, a third set of data points and a third set of labels associated with said data points;
generating and communicating a query to update the correctness of the third set of labels;
receiving a fourth set of inputs from a user, the fourth set of inputs comprising data related to updating of each of the third set of labels;
storing in memory information relating to updating of said third set of labels; and
updating the compliance model based on the third and fourth set of inputs.

7. The method of claim 6, further comprising:
iteratively updating the third set of labels by validation of each the second set of labels by one or more users until the determined accuracy of the data model is achieved.

8. A system for monitoring compliance, comprising:
a processor;
a memory storing program instructions which, when executed by the processor, causes the processor to:
receive a first set of inputs from a user, the first set of inputs comprising information relating to one or more compliance requirements to be monitored;
acquire a profile associated with said user;
generate a first set of data points based on the first set of inputs and one or more attributes acquired from the profile associated with the user;
generating a first set of labels with at least one of the data points from the first set of data points;
validating the first set of labels by one or more users;
generate a second set of labels for additional data points based on validation of first set of labels;
store in memory the first and second set of labels; and
generate training ready data from the first and second set of labels for training a data model.

9. The system of claim 8, wherein the processor is further configured to:
communicate to the user the second set of labels;
receive a second set of inputs from a user, the second set of inputs comprising data related to validation of each of the second set of labels;
store in memory information relating to validation of said second set of labels; and
update the training ready data based on the second set of inputs.

10. The system of claim 9, wherein when the accuracy of the second set of labels is below the predetermined value, the processor is further configured to:
generate a query to determine the accuracy of the data model;
communicate to the user the second set of labels;
receive inputs from the user, the inputs comprising data related to validation of each of the second set of labels;
store in memory information relating to validation of said second set of labels; and
update the training ready data based on the inputs received from the user.

11. The system of claim 10, wherein the processor is further configured to:
iteratively update the second set of labels by validation of each the second set of labels by one or more users until the determined accuracy of the data model is achieved.

12. The system of claim 11, wherein the second set of labels communicated to the user correspond to confidence estimates in a predetermined range, wherein the confidence estimate for each of the second set of data labels is determined by the data model.

13. The system of claim 8, further comprising:
a processor;
a memory storing program instructions which, when executed by the processor, causes the processor to:
receive a third set of inputs from a user, the third set of inputs comprising information relating to one or more compliance requirements;
retrieve, based on the third set of inputs and one or more attributes acquired from the profile associated with the user, a third set of data points and a third set of labels associated with said data points;
generate and communicating a query to update the correctness of the third set of labels;
receive a fourth set of inputs from a user, the fourth set of inputs comprising data related to updating of each of the third set of labels;
store in memory information relating to updating of said third set of labels; and
update the compliance model based on the third and fourth set of inputs.

14. The system of claim 13, wherein the processor is further configured to:
iteratively update the third set of labels by validation of each the third set of labels by one or more users until the determined accuracy of the data model is achieved.

15. A non-transitory computer-readable storage medium storing program instructions for monitoring compliance, the instructions, when executed, perform the steps of:
receiving a first set of inputs from a user, the first set of inputs comprising information relating to one or more compliance requirements to be monitored;
acquiring a profile associated with said user;
generating a first set of data points based on the first set of inputs and one or more attributes acquired from the profile associated with the user;
associating a first set of labels with at least one of the data points from the first set of data points;
validating the first set of labels by one or more users;
generating a second set of labels for additional data points based on validation of the first set of labels;
storing in memory the first and second set of labels; and
generating training ready data from the first and second set of labels for training a data model.

16. The non-transitory computer-readable storage medium of claim 15, further comprising program instructions to perform the steps of:
communicating to the user the second set of labels;
receiving a second set of inputs from a user, the second set of inputs comprising data related to validation of each of the second set of labels;
storing in memory information relating to validation of said second set of labels; and
updating the training ready data based on the second set of inputs.

17. The non-transitory computer-readable storage medium of claim 16, further comprising program instructions to perform the steps of:
generating a query to determine the accuracy of the data model;
wherein, when the accuracy of the data model is below the predetermined value, the method further comprises:
communicating to the user the second set of labels;
receiving inputs from the user, the inputs comprising data related to validation of each of the second set of labels;
storing in memory information relating to validation of said second set of labels; and
updating the training ready data based on the inputs received from the user.

18. The non-transitory computer-readable storage medium of claim 16, wherein the second set of labels communicated to the user correspond to confidence estimates in a predetermined range, wherein the confidence estimate for each of the second set of data labels is determined by the data model.

19. The non-transitory computer-readable storage medium of claim 17, further comprising program instructions to perform the steps of:
iteratively update the second set of labels by validation of each the second set of labels by one or more users until the determined accuracy of the data model is achieved.

20. The non-transitory computer-readable storage medium of claim 15, further comprising instructions, when executed, perform the steps of:
receiving a third set of inputs from a user, the third set of inputs comprising information relating to one or more compliance requirements;
retrieving, based on the third set of inputs and one or more attributes acquired from the profile associated with the user, a third set of data points and a third set of labels associated with said data points;
generating and communicating a query to update the correctness of the third set of labels;
receive a fourth set of inputs from a user, the fourth set of inputs comprising data related to updating of each of the third set of labels;
storing in memory information relating to updating of said third set of labels; and
update the compliance model based on the third and fourth set of inputs.
